(19) United States
(12) Patent Application Publication
(10) Pub. No.: US 2011/0245961 A1
(43) Pub. Date: Oct. 6, 2011

(54) LIBRARY APPARATUS AND INVENTORY CONTROL METHOD

(75) Inventors: Masaki KOBAYASHI, Kawasaki (JP); Hidehiko Komiyama, Kawasaki (JP)

(73) Assignee: FUJITSU LIMITED, Kawasaki-shi (JP)

(21) Appl. No.: 13/076,683

(22) Filed: Mar. 31, 2011

(30) Foreign Application Priority Data
Apr. 6, 2010 (JP) 2010-87945

(51) Int. Cl. G06F 7/00

(52) U.S. Cl. 700/218

(57) ABSTRACT

A library apparatus includes, a cell storage unit to store recording media, a drive unit to read and write information recorded on the media, a transport apparatus configured to transport the media between the cell storage unit and the drive unit, an imaging apparatus to record footage of portable recording media stored in the cell storage unit, an image processor configured to image process footage recorded by the imaging apparatus before entering a low-power mode as first image data, and to image process footage recorded by the imaging apparatus after restoration from a low-power mode as second image data, an image determining unit to determine image difference between the first image data and the second image data, and an inventory processor to conduct an inventory process on the media stored in regions of the cell storage unit that correspond to image difference determined by the image determining unit.

### CROSS-REFERENCE TO RELATED APPLICATIONS

This application is based upon and claims the benefit of priority of the prior Japanese Patent Application No. 2010-087945, filed on Apr. 6, 2010, the entire contents of which are incorporated herein by reference.

1. Field

Embodiments discussed herein relate to a library apparatus and an inventory control method.

2. Background

In the related art, library apparatus provided with portable storage media (cartridges) storing plural information in a cell storage unit have been used to search high-volume data, such as large amounts of information and multimedia in a computer system.

A library apparatus automatically loads, removes, and stores cartridges in cells installed inside a cell storage unit, and stores/plays back data using one or more drive units.

In the case of a library apparatus, since the door of the library apparatus may be freely opened and closed when the power is off, cartridges stored inside cells of the cell storage unit may be manually moved to other cells. In addition, in the case where cartridges fall from their cells due to an earthquake or other disturbance, the storage positions of cartridges stored in the cell storage unit may sometimes change.

In other words, discrepancies may occur between management information indicating identification information for cartridges stored in association with cell storage unit position information which is retained by the library apparatus before power off, and cartridge management information after power on.

For this reason, a library apparatus may prevent discrepancies in storage information from occurring by comparing cartridge storage information retained by the library apparatus in advance to actual cartridge storage information, and conducting an inventory process to make the two sets of storage information consistent. Such an inventory process is normally conducted when the library apparatus is powered on.

An inventory process is a process conducted on all cells installed in a cell storage unit, and involves scanning a barcode from an identification (ID) label affixed to a cartridge and updating the cartridge ID stored in association with cartridge storage information. In an inventory process, the presence or absence of cartridges is also made consistent.

However, since the primary application of a library apparatus of the related art described above is often information backup, in practice the library apparatus may not be in use most of the time. For this reason, there is demand to reduce power consumption by conducting low-power operation (low-power mode) that switches the power off while the library apparatus is not being used, and switches the power on only when the library apparatus is used.

At this point, when a library apparatus is restored from a low-power mode, it may be necessary to conduct an inventory process to ensure the consistency of the storage state of cartridges stored in the cell storage unit of the library apparatus. However, the implementation of low-power operation is not realistic due to the following reasons.

When calculating the time required by an inventory process, the time T of the inventory process may be computed as T=inventory time for 1 cell×number of cells. For this reason, in the case where, for example, the inventory time for a single cell is taken to be 1 second (s) and the number of cells is 200, the time T required by the inventory process becomes approximately 200 s (200 s=1 s×200 cells).

In this way, when an inventory process is conducted upon restoration from a low-power mode, the time required by the inventory process increases, and there is a possibility that instructions from a host computer will time-out due to the increase in processing time. Moreover, since the inventory process time is dependent on the performance of the transport robot that transports cartridges and on the number of cells, it is difficult to set a universal timeout value.

### SUMMARY

According to an aspect of the embodiment, a library apparatus includes, a cell storage unit to store recording media, a drive unit to read and write information recorded on the media, a transport apparatus configured to transport the media between the cell storage unit and the drive unit, an imaging apparatus to record footage of portable recording media stored in the cell storage unit, an image processor configured to image process footage recorded by the imaging apparatus before entering a low-power mode as first image data, and to image process footage recorded by the imaging apparatus after restoration from a low-power mode as second image data, an image determining unit to determine image difference between the first image data and the second image data, and an inventory processor to conduct an inventory process on the media stored in regions of the cell storage unit that correspond to image difference determined by the image determining unit.

The object and advantages of the embodiment will be realized and attained at least by the elements, features, and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a schematic diagram illustrating an overview of a library apparatus in accordance with an embodiment;

FIG. 2 is a diagram illustrating an overview of an inventory process conducted by a library apparatus;

FIG. 3 is a block diagram illustrating a circuit configuration of a library apparatus;

FIGS. 4A to 4D illustrate an inventory control process conducted by a library apparatus; and

FIG. 5 is a flowchart illustrating an inventory control process conducted by a library apparatus.

### DESCRIPTION OF THE EMBODIMENT

Being devised in order to resolve problems of the related art described above, the disclosed technology provides a library apparatus and an inventory control method whereby low-power operation of a library apparatus may be realized, and wherein power consumption may be reduced and timeouts may be avoided by shortening the time required by an inventory process.

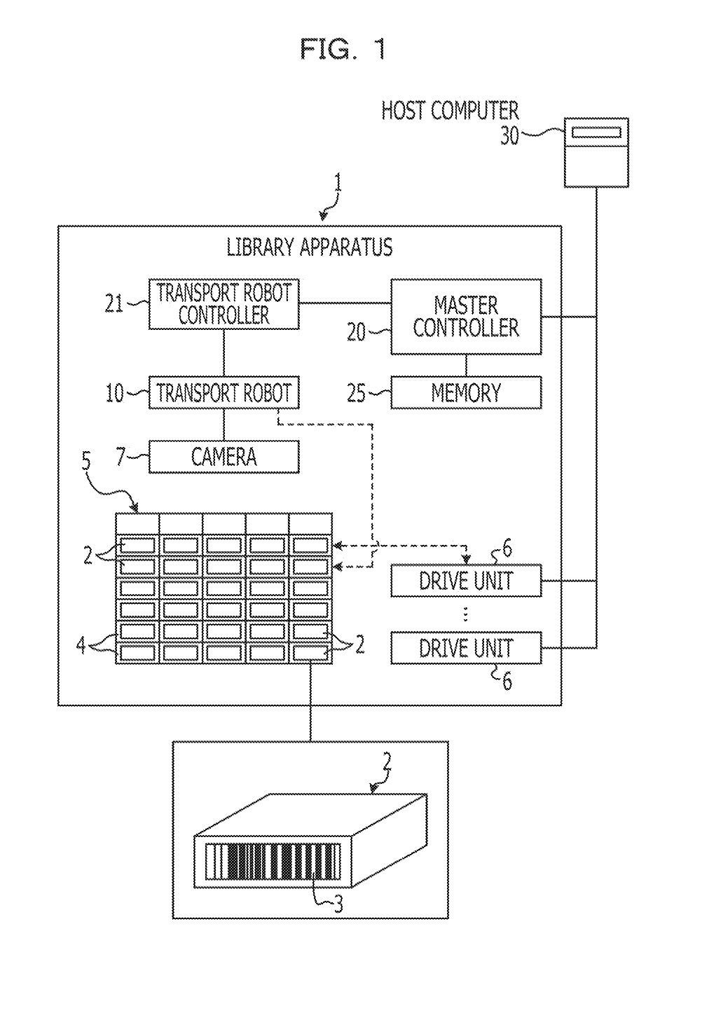

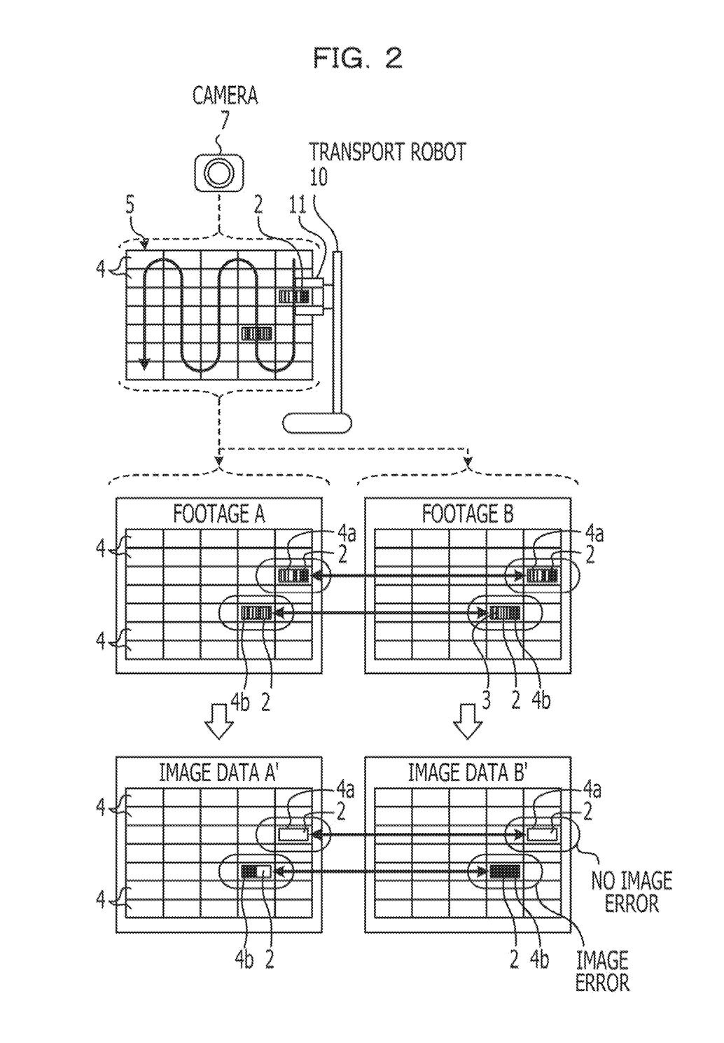

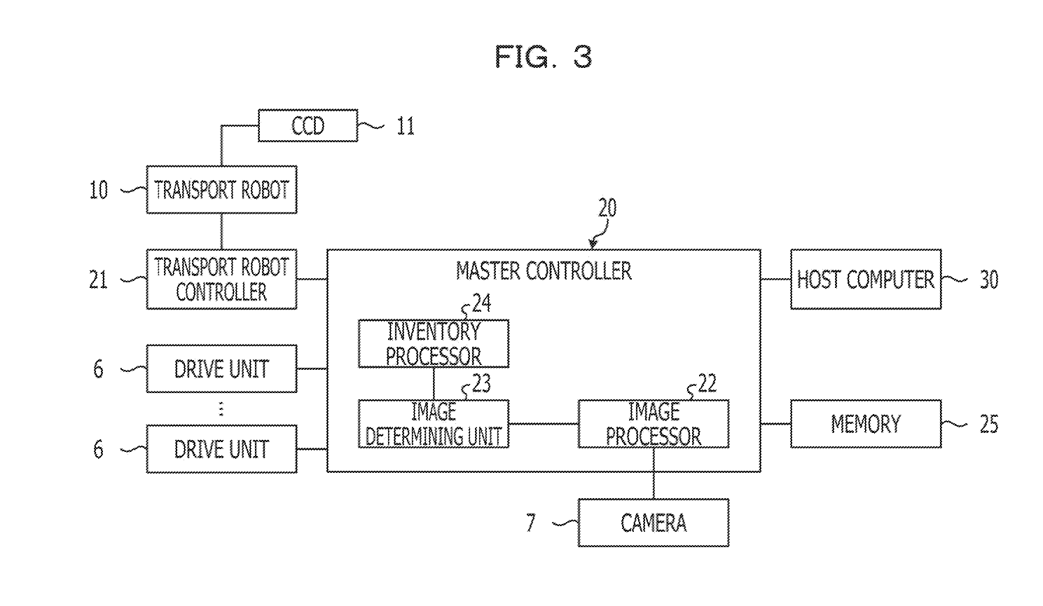

Hereinafter, a preferred embodiment of a library apparatus and inventory control method disclosed herein will be described in detail and with reference to the attached drawings. FIG. 1 is a schematic diagram illustrating an overview of a library apparatus in accordance with an embodiment. FIG. 2 is an explanatory diagram illustrating an overview of an inventory process conducted by a library apparatus. FIG. 3 is a block diagram illustrating a circuit configuration of a library apparatus. However, it should be appreciated that an embodiment is not limited to the embodiment herein.

[Schematic Diagram Illustrating Library Apparatus 1 Internals]

Hereinafter, the internals of a library apparatus 1 will be described in detail. FIG. 1 is a schematic diagram illustrating an overview of a library apparatus 1 in accordance with the present embodiment. As illustrated in FIG. 1, the library apparatus 1 is provided with a cell storage unit 5 formed in a box shape. A plurality of cells 4 storing individual cartridges 2 are installed inside the chassis formed by the cell storage unit 5.

In addition, the library apparatus 1 is provided with one or more drive units 6 that read and write information stored in the cartridges 2 installed inside the cell storage unit 5, and transport robot 10 that inserts and retrieves cartridges 2 with respect to the cell storage unit 5. The transport robot 10 also transports cartridges 2 between the cell storage unit 5 and the one or more drive units 6.

The cartridges 2 are portable recording media that store information, such as magnetic tape or optical disks. An ID label 3 (e.g., a barcode) for identifying a cartridge 2 is affixed to the front of each cartridge 2. The barcodes(ID labels 3) provided on the cartridges 2 are scanned by a charge-coupled device (CCD) 11 of the transport robot 10 (FIG. 3).

The one or more drive units 6 read and write information stored on the cartridges 2 according to instructions from a host computer 30. Information read or written by the one or more drive units 6 is stored in a storage unit of memory 25 in association with the storage information and ID of a cartridge 2.

The camera 7 records the storage state of a plurality of cartridges 2 stored in the cell storage unit 5 as footage. Footage of the cartridges 2 stored inside the cell storage unit 5 may be recorded by the camera 7 at two times: before the library apparatus 1 enters a low-power mode, and after restoration from a low-power mode. The camera 7 is provided at a given position on the transport robot 10, and footage of the cartridges 2 recorded by the camera 7 is recorded at a resolution enabling accurate identification of barcodes(the ID labels 3).

The host computer 30 is communicably coupled to a master controller 20, the cell storage unit 5, and the one or more drive units 6, respectively, and issues instructions for loading and retrieving cartridges 2 to the cell storage unit 5, and for storing or playing back information to the one or more drive units 6.

The transport robot 10 transfers cartridges 2 housed inside the cell storage unit 5 between the cell storage unit 5 and the one or more drive units 6 according to instructions from a transport robot controller 21. The transport robot 10 includes an arm (not illustrated) for gripping the cartridges 2, and a desired cartridge may be detachably held by the arm.

In addition, a CCD 11 is provided on the transport robot 10, and barcode content (information) of the cartridges 2 is scanned by the CCD 11. Content of ID labels 3 scanned by the CCD 11 is stored in the memory 25 as storage information for the cartridges 2.

As illustrated in FIG. 2, a library apparatus 1 in accordance with the present embodiment is provided with a camera 7 that records the storage state of a plurality of cartridges 2 stored inside cells 4 of the cell storage unit 5 as a single set of footage. Footage of the cartridges 2 recorded by the camera 7 before the library apparatus 1 enters a low-power mode is image processed as first image data, and footage of the cartridges 2 after restoration from a low-power mode is image processed as second image data. A feature image expressed by the first image data is compared to a feature image expressed by the second image data, and an inventory process is conducted based on the image error therebetween.

In other words, a method for identifying the image error between first image data and second image data may involve, for example, binarizing the two sets of footage recorded by the camera 7, and using feature value extraction technology to determine differences in feature points for both sets of image data. Also, in cases where differences exist between a feature image expressed by a set of image data and a feature image expressed by another set of image data (e.g., when image error exists), regions with image error are specified. An inventory process is then conducted on the specified regions (e.g., a differential inventory process). Image extraction technology based on quadtree image subdivision, for example, may be used to specify regions with image error.

Thus, in the present embodiment, an inventory process conducted in order to check and ensure the consistency of cartridges 2 stored inside the cell storage unit 5 of a library apparatus 1 includes an inventory process of the related art, and a differential inventory process that ensures consistency inside the library apparatus 1 in a short amount of time.

More specifically, the camera 7 may record footage A of cartridges 2 stored in the cell storage unit 5 before a low-power mode. Similarly, the camera 7 may record footage B of cartridges 2 stored in the cell storage unit 5 after restoration from a low-power mode. Differences between the footage A and the footage B is compared. Herein, in the present embodiment, image processing is conducted taking footage A and footage B recorded by the camera 7 as image data expressing respective features.

Footage of ID labels 3 (barcodes) on cartridges 2 recorded by the camera 7 is image processed as a feature image (image data), and determined as image error regions for cartridges 2 inside the cell storage unit 5.

In other words, as illustrated in FIG. 2, image processing is conducted that binarizes footage recorded by the camera 7 as image data. In addition, recorded footage A and footage B is converted into image data A′ and image data B′ that may be determined as feature images by using image processing that utilizes a histogram or other feature value extraction technology.

As illustrated in FIG. 2, in an inventory process (differential inventory process) of the present embodiment, when comparing image data A′ before a low-power mode and image data B′ after restoration from a low-power mode recorded by the camera 7, image data of a cartridge 2 is substantially identical in a cell 4a of the cell storage unit 5, and a region with image error does not exist.

In contrast, in a cell 4b of the cell storage unit 5, image data of a cartridge 2 differs, and thus the cell 4b becomes a region determined to have image error. For this reason, in the present embodiment, an inventory process is conducted on the cartridge 2 in the cell 4b stored in the image error region.

Herein, when the chassis forming the cell storage unit 5 of the library apparatus 1 is large, in some cases the camera 7 might not be able to record footage of the entire cell storage unit 5 at once. For this reason, in the present embodiment, the cell storage unit 5 may be divided into a given number of regions, and the divided regions may be recorded a plurality of times by the camera 7.

[Circuit Configuration of Library Apparatus 1]

FIG. 3 is a block diagram illustrating a circuit configuration of a library apparatus in accordance with the first embodiment. As illustrated in FIG. 3, a master controller 20 is provided with an image processor 22, an image determining unit 23, and an inventory processor 24. In addition, the master controller 20 is coupled to one or more drive units 6, a camera 7, a transport robot 10, memory 25, a transport robot controller 21, and a host computer 30.

The master controller 20 controls operation of the library apparatus 1 overall. The transport robot controller 21 controls operation of the transport robot 10 according to instructions from the host computer 30. More specifically, the transport robot controller 21 issues instructions regarding factors such as position for the transport of cartridges 2 by the transport robot 10 conducted between the cell storage unit 5 and the one or more drive units 6.

The image processor 22 image processes footage of the storage state of a plurality of cartridges 2 stored in the cell storage unit 5 that is recorded by the camera 7. More specifically, the image processor 22 converts footage of cartridges 2 stored in the cell storage unit 5 recorded by the camera 7 before a low-power mode and after restoration from a low-power mode into image data.

The image determining unit 23 determines image error between image data before a low-power mode and image data after restoration from a low-power mode that has been image processed by the image processor 22, based on feature images of the respective image data.

The inventory processor 24 conducts an inventory process on a cartridge 2 stored inside the cell storage unit 5 in a region with image error determined by the image determining unit 23. More specifically, when differences exist between image data of cartridges 2 stored in the cell storage unit 5 before a low-power mode and image data of cartridges 2 after restoration from a low-power mode, an inventory process is conducted on image error regions where the image error occurs.

The host computer 30 is coupled to the master controller 20, the one or more drive units 6, and the transport robot controller 21, and issues instructions for loading and retrieving cartridges 2 stored in the cell storage unit 5, and for storing or playing back information using the one or more drive units 6.

The memory 25 stores storage information (position information) for a plurality of cartridges 2 stored inside the cell storage unit 5 of the library apparatus 1 in association with IDs of the cartridges 2. In addition, in the present embodiment, the memory 25 respectively stores image data that has been recorded by the camera 7 and image processed before the library apparatus 1 enters a low-power mode and after restoration from a low-power mode. Flash memory or battery backed static random-access memory (SRAM) may be used for the memory 25, for example.

[Inventory Control Process Conducted by Library Apparatus 1]

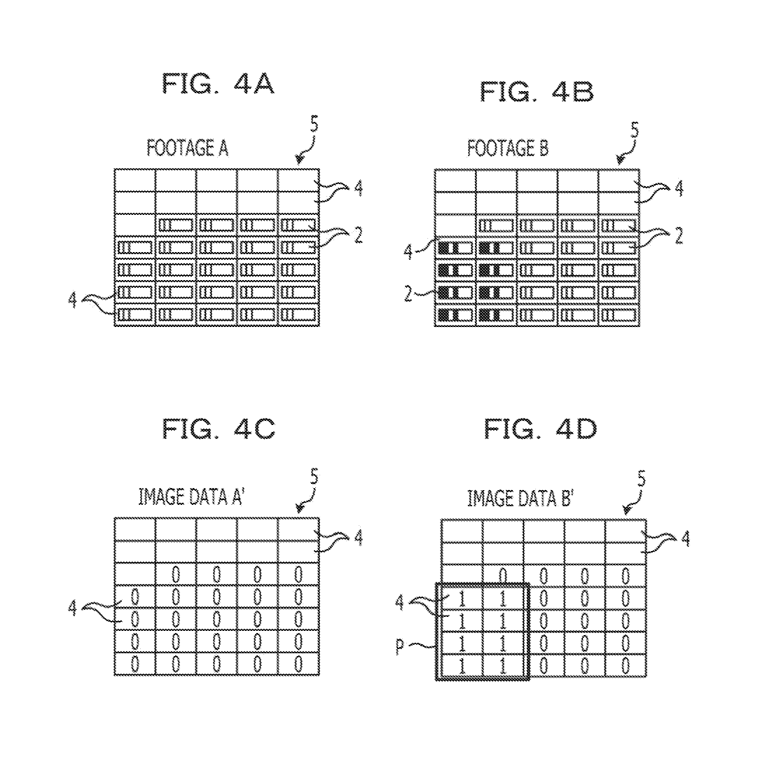

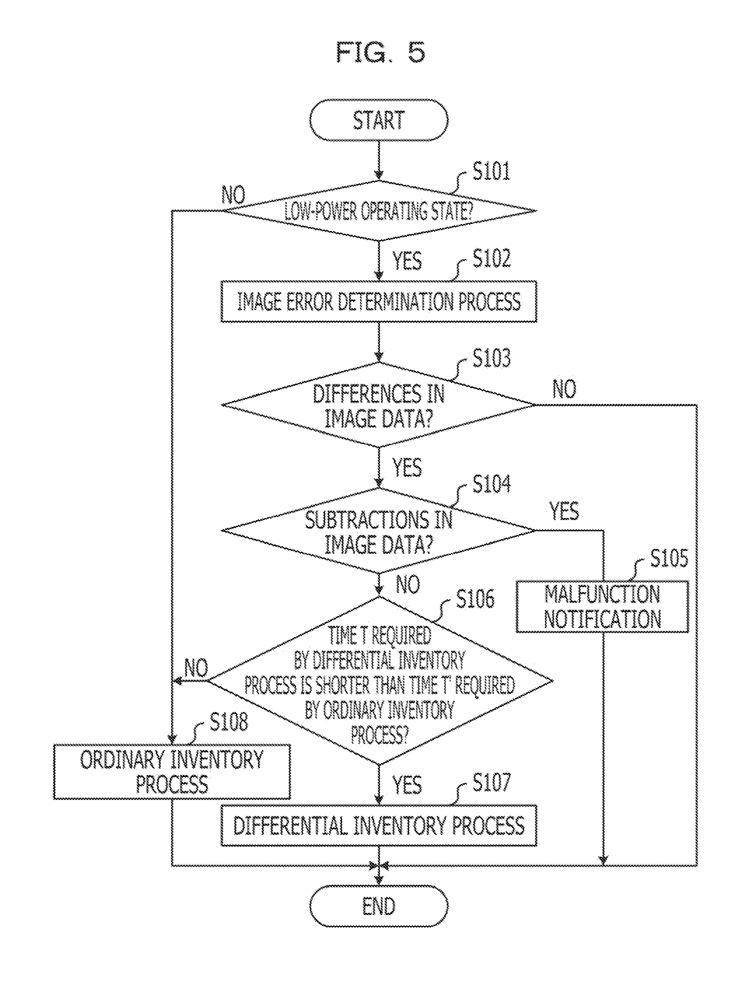

Next, an inventory control processing sequence will be described in detail and with reference to FIGS. 4A to 5. FIGS. 4A to 4D illustrate an inventory control process conducted by a library apparatus. FIG. 5 is a flowchart illustrating an inventory control process conducted by a library apparatus 1 in accordance with the present embodiment.

As illustrated in the flowchart in FIG. 5, in an operation S101, it is determined whether or not the operating state of the library apparatus 1 is a low-power operating state (low-power mode). When the operating state of the library apparatus 1 is a low-power mode (S101 Yes), the process proceeds to an image data image error determining process in an operation S102. The image data image error determining process compares the consistency of image data before a low-power mode and image data after restoration from a low-power mode.

In contrast, when the operating state of the library apparatus 1 is not a low-power mode (S101 No), the library apparatus 1 conducts an ordinary inventory process (operation S108), and the inventory control process is terminated (END). More specifically, boot up of the library apparatus 1 is completed, and input/output (IO) reception between the library apparatus 1 and the host computer 30 becomes possible.

Returning to operation S102, in the image error determining process conducted in operation S102, a process is conducted by the image determining unit 23 to compare the consistency of footage (image data) before a low-power mode and footage (image data) after restoration from a low-power mode that has been recorded by the camera 7.

More specifically, footage A (FIG. 4A) recorded by the camera 7 and expressing cartridges 2 stored in the cell storage unit 5 before a low-power mode is converted to image data A′ (FIG. 4C) by image processing conducted by the image processor 22 (FIG. 3).

In addition, footage B (FIG. 4B) expressing cartridges 2 after restoration from a low-power mode is converted to image data B′ (FIG. 4D) by image processing. For this reason, a process is conducted to determine image error between the image data A′ and the image data B′.

It is determined whether or not differences exist in the image error of the image data by a determination in an operation S103, and when image error does exist between the image data A′ and the image data B′ (S103 Yes), the process proceeds to an operation S104. In contrast, when it is determined by the determination in operation S103 that image error does not exist between the image data A′ and the image data B′ (S103 No), the process is terminated (END).

Next, in an operation S104, image data before a low-power mode in the library apparatus 1 is compared to image data after restoration from a low-power mode, and it is determined whether or not subtractions exist in the image data. More specifically, the presence or absence of cartridges 2 stored inside the cell storage unit 5 after restoration from a low-power mode is determined, and it is determined whether or not the number of cartridges has decreased. When subtractions do exist in the image data (S104 Yes), a malfunction notification that reports a malfunction is issued (S105).

In other words, when subtractions exist in the image error of image data, it is conceivable that cartridges 2 inside the cell storage unit 5 may have fallen due to an earthquake or other disturbance. For this reason, a notification is issued to inform the user that cartridges 2 stored inside the cell storage unit 5 of the library apparatus 1 are not properly stored, and a differential inventory process according to the present embodiment is not conducted.

In contrast, when it is determined by the determination in operation S104 that subtractions do not exist in the image data and that the number of cartridges 2 stored inside the cells 4 of the cell storage unit 5 has not decreased (S104 No), the process proceeds to an operation S106.

In operation S106, the length of a time T′ required by an ordinary inventory process is compared to the length of a time T required by a differential inventory process. When it is determined that the time T required by a differential inventory process is not shorter than the time T′ required by an ordinary inventory process (S106 No), the process proceeds to an operation S108. In operation S108, an ordinary inventory process is conducted. As described earlier, an ordinary inventory process searches all storage information for cartridges 2 stored inside the cell storage unit 5.

Herein, the time T required by a differential inventory process becoming longer than the time T′ required by an ordinary inventory process entails the case where a large amount of image error occurs in image data. More specifically, factors such as the travel distance (forward travel and reverse travel) of the transport robot 10 that travels when conducting an inventory process become involved as a result of regions with large amounts of image error becoming dispersed.

In contrast, when it is determined by the determination in S106 that the time T required by a differential inventory process is shorter than the time T′ required by an ordinary inventory process (S106 Yes), a differential inventory process is conducted on regions where image error is occurring (S107).

In other words, if the image data A′ before a low-power mode is compared to the image data B′ after restoration from a low-power mode as illustrated in FIGS. 4A to 4D, a region P of cells 4 in the cell storage unit 5 becomes a region determined to have image error in image data of the cartridges 2. For this reason, in the present embodiment, an inventory process is conducted on cartridges 2 stored in the region P of cells 4 in the cell storage unit 5.

At this point, when the storage information for cartridges 2 before a low-power mode and the storage information for cartridges 2 after restoration from a low-power mode differ when executing a differential inventory process, storage information (position information) of cartridges 2 stored in the memory 25 may be overwritten by the IDs (barcode information) of newly identified cartridges 2 as update data.

In other words, the update data becomes correct storage information for cartridges 2 stored in the cell storage unit 5. In so doing, a given cartridge 2 indicated by instructions from the host computer 30 may be correctly accessed, even in cases where the storage positions of cartridges 2 have moved.

In this way, in an inventory control process of the present embodiment, control may be conducted that takes into account the time T required by a differential inventory process becoming longer than the time T′ required by an ordinary inventory process. In other words, by comparing the time T required by a differential inventory process to the time T′ required by an ordinary inventory process as described above, the inventory process determined to have a shorter processing time may be preferentially executed. In so doing, a shortened inventory process may be conducted, and timeouts occurring between the library apparatus 1 and the host computer 30 may be avoided.

As described in the foregoing, a library apparatus 1 in accordance with the present embodiment records the storage state of cartridges 2 stored in a cell storage unit 5 before a low-power mode and after restoration from a low-power mode as footage recorded by a camera 7. In addition, footage of cartridges 2 before a low-power mode and after restoration from a low-power mode is made into first image data and second image data by image processing.

Image error between a feature image of the first image data and a feature image of the second image data is determined by an image determining unit 23, and an inventory process is conducted on cartridges 2 stored in regions where image error exists between the first image data and the second image data. In so doing, an inventory process that ensures the consistency of cartridges 2 in the library apparatus 1 may be efficiently conducted when the library apparatus 1 boots up normally from power off and when the library apparatus 1 is restored from low-power operation. As a result, low-power operation of a library apparatus may be realized, and reduction of power consumption due to shortened inventory processing time may be realized.

Furthermore, since the time required by an inventory process may be reduced, it becomes possible to use a library apparatus in a short amount of time after restoration from a low-power mode. In so doing, timeouts by a host computer 30 may be avoided.

The foregoing thus describes an embodiment, but is should be appreciated that embodiments discussed herein are not limited thereto, and that various other embodiment may also be realized without departing from the scope of the technical ideas stated in the claims. Moreover, the advantages discussed in the foregoing embodiment are not limited thereto.

Among the respective processes described in the foregoing embodiment, all or part of the processes described as being conducted automatically may be conducted manually, or alternatively, all or part of the processes described as being conducted manually may be conducted automatically by known methods. In addition, processing sequences, control sequences, specific names, and information including various data and parameters illustrated in the foregoing embodiment may be arbitrarily modified unless otherwise noted.

It should also be appreciated that respective components of respective apparatus illustrated in the drawings are representations of functional concepts, and that an embodiment is not necessarily required to be physically configured in a manner illustrated in the drawings. In other words, the specific configuration in which individual apparatus are separated or integrated is not limited to that illustrated in the drawings, and all or part of the apparatus herein may be functionally or physically separated or integrated in arbitrary units according to load and usage conditions of respective processes and other factors.

Furthermore, all or an arbitrary part of the respective processing functions conducted by respective apparatus may be realized by a central processing unit (CPU) (or other microprocessor such as a micro processing unit (MPU) or micro controller unit (MCU)) or by a program parsed and executed by such a CPU (or other microprocessor such as an MPU or MCU). Alternatively, all or an arbitrary part of the respective processing functions conducted by respective apparatus may be realized in hardware by wired logic.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Although the embodiment(s) of the present invention(s) has(have) been described in detail, it should be understood that the various changes, substitutions, and alterations could be made hereto without departing from the spirit and scope of the invention.

What is claimed is:

1. A library apparatus that stores data, comprising:
a cell storage unit including a plurality of storage cells storing portable recording media;
a drive unit configured to read and write information recorded on the portable recording media according to instructions from a management apparatus;
a transport apparatus configured to transport the portable recording media between the cell storage unit and the drive unit;
an imaging apparatus configured to record footage of portable recording media stored in the cell storage unit;
an image processor configured to image process footage recorded by the imaging apparatus before entering a low-power mode as first image data, and to image process footage recorded by the imaging apparatus after restoration from a low-power mode as second image data;
an image determining unit configured to determine image difference between the first image data and the second image data; and
an inventory processor configured to conduct an inventory process on portable recording media stored in regions of the cell storage unit that correspond to image difference determined by the image determining unit.

2. The library apparatus according to claim 1, wherein
the inventory processor compares the time required by an ordinary inventory process to the time required by an inventory process after restoration from a low-power mode, and conducts an inventory process for low-power mode in the case where the inventory processing time after restoration from a low-power mode is shorter than the ordinary inventory processing time.

3. The library apparatus according to claim 1, wherein
the imaging apparatus records IDs expressing storage information for the portable recording media at a given resolution.

4. An inventory control method for a library apparatus provided with a cell storage unit including cells storing portable recording media, a drive unit that reads and writes information recorded on the portable recording media, and a transport apparatus that transports the portable recording media between the cell storage unit and the drive unit, the method comprising:
conducting a first imaging by recording the cell storage unit before entering a low-power mode as first image data;
conducting a second imaging by recording the cell storage unit after restoration from a low-power mode as second image data;
determining image error between the first image data recorded by the first imaging operation and the second image data recorded by the second imaging operation; and
conducting an inventory process on portable recording media stored in the cell storage unit corresponding to positions where image difference exists in the case where it is determined in the image difference determining operation that image difference exists between the first image data and the second image data.

5. The inventory control method for a library apparatus according to claim 4, wherein
the inventory processing operation compares the time required by an ordinary inventory process to the time required by an inventory process after restoration from a low-power mode, and conducts an inventory process for low-power mode in the case where the inventory processing time after restoration from a low-power mode is shorter than the ordinary inventory processing time.
